(19) United States
(12) Patent Application Publication
(10) Pub. No.: US 2004/0016617 A1
(43) Pub. Date: Jan. 29, 2004

(54) Electromagnetic clutch

(76) Inventors: Yuichi Imai, Saitama (JP); Daisuke Asakuri, Saitama (JP); Takashi Watanabe, Saitama (JP); Kuniaki Shimizu, Saitama (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/617,772

(22) Filed: Jul. 14, 2003

(30) Foreign Application Priority Data
Jul. 24, 2002 (JP) 2002-214859

(51) Int. Cl. F16D 27/112

(52) U.S. Cl. 192/84.961; 192/107 M

(57) ABSTRACT

In order to increase the transfer torque by improving the level of magnetic attraction between the friction surface of an armature and the friction surface of a rotor in an electromagnetic clutch, a magnetism blocking portion for blocking a flow of magnetism is formed to extend along the circumferential direction at an approximate middle position of a disk of the armature along the radial direction. In a similar manner, a plurality of magnetism blocking portions for blocking the flow of magnetism are formed to extend along the circumferential direction at the friction surface of the rotor of the electromagnetic clutch at varying positions set along the radial direction. A plurality of magnetic poles are formed with these magnetism blocking portions, and the facing area of a given outer circumference-side magnetic pole is set smaller than the facing area of the corresponding inner circumference-side magnetic pole by forming these magnetism blocking portions at specific, appropriate positions.

### BACKGROUND OF THE INVENTION

1. Technical Field

The present invention relates to an electromagnetic clutch employed to relay motive power which needs to be communicated from a motive power source to a driven device such as a compressor.

2. Description of the Related Art

Electromagnetic clutches in the related art include those disclosed in Japanese Unexamined Patent Publication No. S 56-124736, Japanese Unexamined Patent Publication No. H 11-141572 and Japanese Unexamined Patent Publication No. 2002-48156. The electromagnetic clutch disclosed in Japanese Unexamined Patent Publication No. S 56-124736, having an armature disk achieved by inserting a ring constituted of a non-magnetic material such as copper between two separate disk pieces, one disposed on the outer circumferential side and the other disposed on the inner circumferential side, and then by bringing the two disk pieces together to form an integrated unit through caulking (a metal-flow type armature), blocks the magnetism passing through the armature disk with the non-magnetic material to allow the entire magnetism to flow over the friction surface of the rotor set on the opposite side without any leakage of the magnetic flux, and thus, achieves an advantage in that the level of the magnetic attraction improves due to an increased effective magnetic flux.

In the electromagnetic clutch disclosed in Japanese Unexamined Patent Publication No. H 11-141572, which adopts a structure similar to that adopted in Japanese Unexamined Patent Publication No. S 56-124736, two annular slits 20 are provided over a distance from each other along the radial direction at the attracting surface of a rotor 3, an excitation coil 2 is divided along the radial direction at an approximate middle area relative to the two annular slits, the outer circumference of an inner ring 24 and the inner circumference of an outer ring 25 are set to face opposite each other over a distance and then the inner ring 24 and the outer ring 25 are coupled with each other through resistance welding by using a non-magnetic metal 30. The magnetic clutch disclosed in this publication, too, prevents magnetic flux leakage, and since the line of magnetic force is allowed to run between the excitation coil 2 and the attracting surface of the rotor 3 twice over the entire circumference, the excitation coil 2 can be held onto the attracting surface of the rotor 3 with a high level of magnetic force.

The electromagnetic clutches in the related art described above, with which a transfer torque achieving a level comparable to that in the related art can be generated with a coil having considerably lower capacity for magnetomotive force, e.g., approximately 20% of the magnetomotive force required in an electromagnetic clutch adopting a single armature structure in the related art that have a plurality of elongated holes formed along the circumferential direction approximately halfway between the central hole and the periphery of the armature, i.e., a single disk along the radial direction and bridge portions formed between the longitudinal holes, have proved effective in achieving miniaturization, low weight and reduced power consumption.

However, in order to manufacture the metal-flow type electromagnetic clutch disclosed in Japanese Unexamined Patent Publication No. S 56-142736, the inner side of the outer circumference-side disk piece and the outer side of the inner circumference side disk piece need to be knurled, a ring constituted of a non-magnetic material must be inserted between the two disk pieces and then the two disk pieces must be connected as an integrated unit through caulking. As a result, due to the numerous manufacturing steps that must be executed, the manufacturing cost becomes high. In addition, the presence of the ring constituted of the non-magnetic material raises the weight of the electromagnetic clutch.

The electromagnetic clutch disclosed in Japanese Unexamined Patent Publication No. H 11-141572, too, requires manufacturing steps for inserting a non-magnetic member between the inner and outer disk pieces of the armature and for connecting the non-magnetic member through resistance welding, and thus fails to address the problems of the electromagnetic clutch disclosed in Japanese Unexamined Patent Publication No. S 56-142736, i.e., a large number of manufacturing steps that need to be executed and a significant increase in the weight due to the presence of the non-magnetic member.

It goes without saying that minimizing cost is a critical objective in the manufacturing industry, and while it is obvious that both a cost reduction and a weight reduction can be better achieved by using a single disk type armature which does not adopt either of the structures of the armatures in the related art described above, the problem of such a single disk type armature, i.e., the level of the force of attraction lowered due to the magnetic flux leakage via the bridge portion between the longitudinal holes, still needs to be addressed.

### SUMMARY OF THE INVENTION

In order to address the problems discussed above, while adopting a single disk type armature, the electromagnetic clutch according to the present invention includes a modified structure at the friction surface of the rotor set to face opposite the armature so that a transfer torque equivalent to that achieved through a metal-flow type armature is realized without having to increase the magnetomotive force of the coil.

Accordingly, in the electromagnetic clutch according to the present invention having an excitation coil, a rotor with a rotatably supported friction surface and an armature that includes a disk with a friction surface facing opposite the friction surface of the rotor, which causes the disk to be held onto the rotor by using an electromagnetic force generated as power is supplied to the excitation coil, a magnetism blocking portion for blocking the flow of magnetism is formed to extend along the circumferential direction over a middle area of the disk of the armature along the radial direction, a plurality of magnetism blocking portions for blocking the flow of magnetism are formed to extend along the circumferential direction of the pulley at various positions at the friction surface along the radial direction, a plurality of magnetic poles are formed along the circumferential direction between the friction surface of the rotor and the friction surface of the armature disk, and the area over which a given outer circumference-side electromagnetic pole faces opposite the corresponding inner circumference-side electromagnetic pole is smaller than the facing area of the inner circumference-side electromagnetic pole.

With the facing area of the outer circumference-side electromagnetic pole formed smaller than the facing area of the inner circumference-side electromagnetic pole, the magnetic flux density increases at the outer circumference-side magnetic pole and an increase in the contact surface pressure is achieved. Combined with a larger torque radius on the outer circumference side, it becomes possible to improve the transfer torque without having to increase the magnetomotive force of the coil.

The magnetism blocking portion at the disk is constituted of a plurality of discontinuous longitudinal holes formed along the circumferential direction. The magnetism blocking portions at the friction surface of the rotor may be formed as longitudinal holes, grooves or a combination thereof formed along the circumferential direction. A plurality of magnetic poles are formed along the radial direction by the magnetism blocking portions at the disk and the rotor, and by forming the longitudinal holes or grooves in specific shapes to constitute the magnetism blocking portions at the friction surface of the rotor, the facing area of each outer circumference-side electromagnetic pole can be set smaller than the facing area of the corresponding inner circumference-side magnetic pole.

When the magnetic poles include a first pole, a second pole, a third pole and a fourth pole with the first and second poles constituting outer circumference-side magnetic poles and the third and fourth poles constituting inner circumference-side magnetic poles, the facing area of the second pole is 1˜1.05, the facing area of the third pole is 1.05˜1.10 and the facing area of the fourth pole is at least 1.05 relative to the facing area of the first pole set at 1. Namely, the facing area of the first pole, i.e., the outer circumference-side magnetic pole is set smaller than the facing area of the third pole and the facing area of the second pole is set smaller than the facing area of the fourth pole to ensure that the outer circumference-side magnetic poles are always smaller than the inner circumference-side magnetic poles.

The facing area of the first magnetic pole is set to a range above 800 mm.

The friction surface of the armature disk and the friction surface of the rotor are set so that their distance widens toward the inner circumference side relative to the distance on the outer circumference side. More specifically, there should be a difference of 30˜80 μm in the height between the outer circumference side and the inner circumference side. Through the structure, it is ensured that the outer circumference side first becomes magnetically attracted to achieve a sufficiently large transfer torque from the initial stage of the connection.

A chromate film is formed to cover the disk of the armature. As a result, an improvement is achieved in the coefficient of friction resulting in an increase in the friction torque and, at the same time, slippage occurs less readily when the disk and the rotor become magnetically engaged, thereby reducing the noise occurring when the magnetic engagement takes place.

### BRIEF DESCRIPTION OF THE DRAWINGS

Numerous novelties that characterize the present invention are described in detail in the claims attached to the specification. The attached drawings presenting a preferred embodiment of the present invention should be referred to in order to better understand the structure and objects of the present invention.

FIG. 1 is a sectional view of the electromagnetic clutch according to the present invention;

FIG. 2 is a front view of the electromagnetic clutch;

FIG. 3 is a front view of the rotor employed in the electromagnetic clutch;

FIG. 4 is a partial sectional view in an enlargement, illustrating the relationship between the armature and the rotor in the electromagnetic clutch; and

FIG. 5 presents a table in which a product in the related art and electromagnetic clutch according to the present invention are compared with each other.

### DETAILED DESCRIPTION OF THE PREFERRED EMBODIMENT

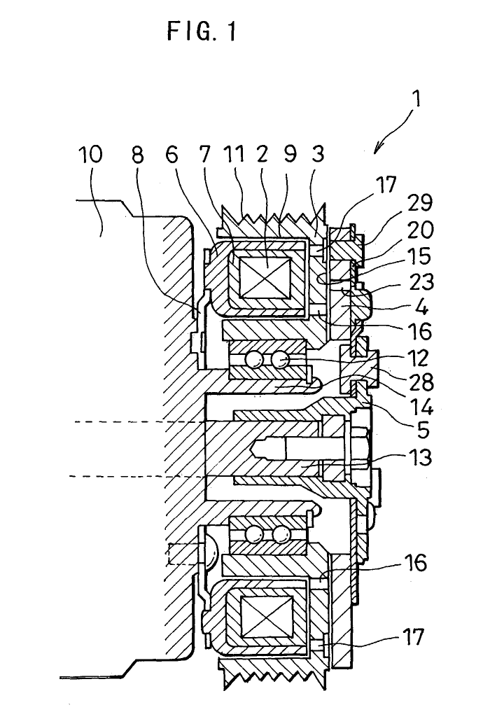

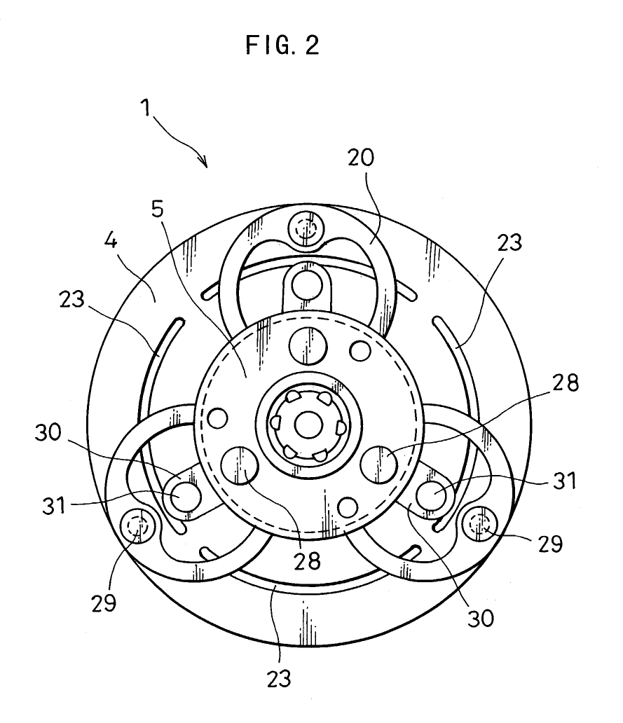

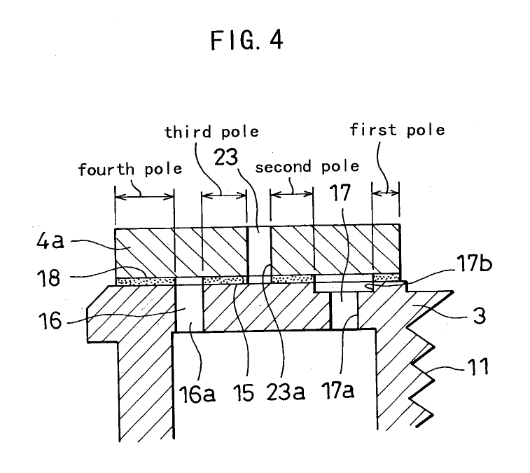

The following is an explanation of an embodiment of the present invention, given in reference to the drawings. An electromagnetic clutch 1 in FIGS. 1 through 4, which makes it possible to continuously supply rotational motive power from a motive power source such as an engine or a motor to a driven device such as a compressor, includes an excitation coil 2, a rotor 3 which rotates at a circumferential surface of the excitation coil 2, an armature 4 provided to face opposite the rotor 3 and a hub 5 coupled with the armature 4.

The excitation coil 2 is wound around a bobbin 7 provided inside a stator housing 6 and is firmly secured to a housing 10 for the driven device via a mounting plate 8. The stator housing 6, in which the excitation coil 2 is housed, in turn, is housed inside an annular groove 9 opening toward the driven device housing 10 with a specific clearance.

The rotor 3 formed in a ring shape includes grooves 11 formed at its outer circumference, at which a connecting belt used to achieve a connection with the motive power source. The rotor 3 is rotatably fitted over the outer circumferential surface of a cylindrical portion 14 that axially supports a drive shaft 13 of the driven device via a bearing 12 provided at the inner circumference. The side surface of the rotor 3 on the side opposite from the driven device is formed as a flat surface substantially perpendicular to the center of the axis and constitutes a friction surface 15 facing opposite the armature 4 to be detailed later. At the friction surface 15, a magnetism blocking portion 16 and a magnetism blocking portion 17 that block passage of magnetism generated by the excitation coil 2 are formed discontinuously to extend along the circumferential direction over varying distances from the center of the axis.

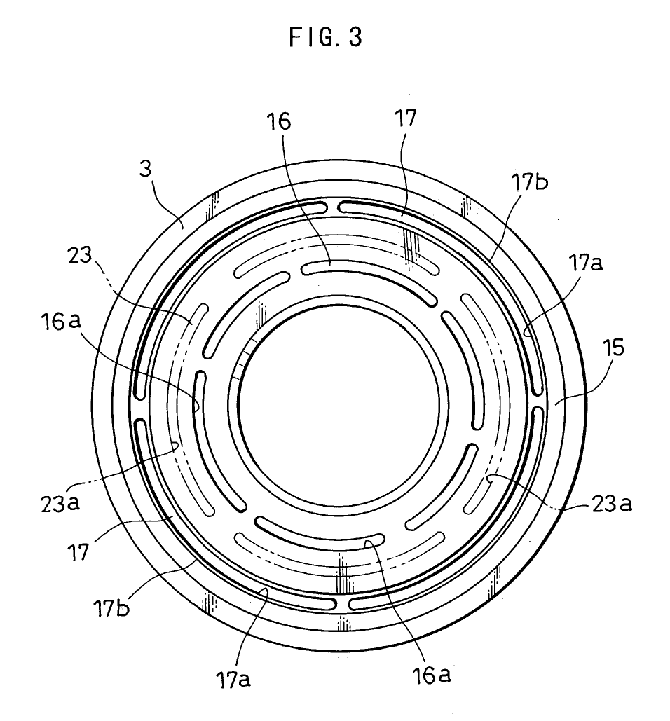

Namely, the magnetism blocking portion 16 on the inner side is constituted with six arc-shaped longitudinal holes 16a which are formed successively, and the magnetism blocking portion 17 is constituted of four arc-shaped longitudinal holes 17a and a single annular groove 17b with larger dimensions than those of the longitudinal holes which is formed toward the disk, as shown in FIG. 3. The widths of the magnetism blocking portions 16 and 17 should be determined as appropriate in relation to the dimensions of a magnetism blocking portion 23 formed at the disk 4a to be detailed below.

The armature 4 includes the circular disk 4a having a friction surface 18 facing opposite the friction surface 15 of the rotor 3 and is set by aligning the central axis at the outer side of the hub 5 mounted at an end of the drive shaft 13 with a bolt 19. The armature 4 and the hub 5 are connected with each other via a plate spring 20 so as to be allowed to rotate as an integrated unit while the armature 4 is allowed to move along the axis of the disk 4a.

At the disk 4a constituting the armature 4, which is formed by using a single disk plate constituted of a magnetic material, four arc-shaped longitudinal holes 23a are formed discontinuously so as to constitute the magnetism blocking portion 23 at an approximate middle area of the disk along the radial direction. Bridge portions are formed between the individual longitudinal holes 23. The longitudinal holes 23a are set between the inner longitudinal holes 16a and the outer longitudinal holes 17a formed at the rotor 3. It is to be noted that a chromate film constituted of chromium oxide is formed over the friction surface 18 of the armature 4 to reduce the slipping noise when the disk and the rotor 3 become magnetically engaged with each other by improving the coefficient of friction.

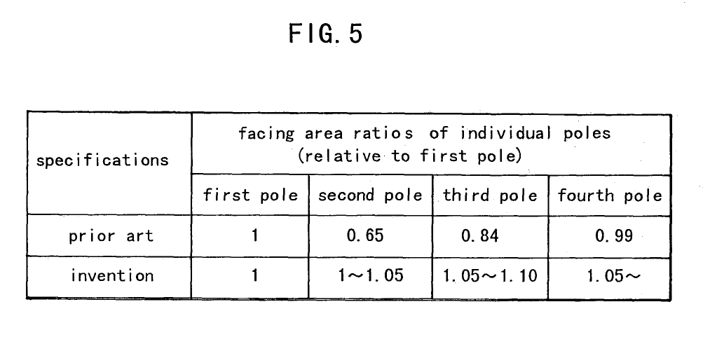

The friction surface 18 of the armature 4 and the friction surface 15 of the rotor 3 form four magnetic poles at varying positions along the radial direction with the magnetism blocking portions 16, 17 and 23, i.e., a first pole, a second pole a third pole and a fourth pole are film starting from the outermost side. The first pole and second poles are outer circumference-side magnetic poles and the third and fourth poles are inner circumference-side magnetic poles. The facing area of the second pole is set to 1˜1.05, the facing area of the third pole is set to 1.05˜1.10 and the facing area of the fourth pole is set to 1.05 or larger, relative to the facing area of the first pole set to 1, as shown in FIG. 5.

Thus, the outer circumference-side magnetic poles, i.e., the first and second poles, have of larger facing areas than those of the inner magnetic poles, i.e., the third and fourth poles. It is to be noted that the term “magnetic pole” is used to refer to an area through which a line of magnetic force from the outside can be regarded to be attracted toward a magnet or through which a line of magnetic force is released from a magnet toward the outside. Each pole forms a pair with a corresponding pole. The first pole, which ranges from the end of the disk 4a to the right end of the annular groove 17a on the outer circumference side of the rotor 3, has the smallest facing area achieved by setting the width of the annular groove 17b to a specific value.

The second pole ranges from the left end of the annular groove 17b of the rotor 3 to the right end of longitudinal holes 23a at the disk 4a and has a larger facing area than the first pole, which is assured by setting the machining position for the left end of the annular groove 17b at a specific position. The third pole ranging from the longitudinal holes 23a at the disk 4a to the right end of the longitudinal holes 16a on the inner circumference side of the rotor 3 has a larger facing area than the second pole. The fourth pole ranging from the left end of the longitudinal holes 16a on the inner circumference side of the rotor 3 to the left end of the disk 4a has a facing area that is at least as large as that of the third pole.

The plate spring 20 extends radially from the hub 5, with one end thereof firmly attached to the hub 5 and its other end firmly attached to the disk 4 with rivets 28 and 29. In the structure adopted in the embodiment, three plate springs 20 each formed so as to achieve an overall annular shape are provided over 120° intervals. At the plate springs 20, projecting pieces 30 extending so as to face opposite the inner disk piece 22 are provided and buffer members 31 constituted of rubber or the like are disposed at the projecting pieces 30 so that noise and vibration occurring when the armature 4 having been held onto the rotor 3 is released by the restorative force of the plate springs 20 are absorbed at the buffer members 31.

As the rotor 3 is caused to rotate by a drive force imparted from the drive source and a power supply to the excitation coil 2 starts in the structure described above, a magnetic path through which the resulting magnetism makes two return trips by first passing through the first pole formed over the friction surface 15 of the rotor 3 and the friction surface 18 of the armature disk 4a, passing through the second pole to reach the rotor 3, then passing through the third pole to return to the disk 4a of the armature and passing through the fourth pole to travel through the rotor 3 is formed as indicated by the dotted-line in FIG. 3.

Thus, the disk 4a of the armature 4 becomes displaced toward the rotor 3 against the elastic force imparted by the plate springs 20, the friction surface 15 of the rotor 3 and the friction surface 18 of the armature become magnetically engaged, and the rotational motive force is communicated from the rotor 3 to the armature 4 to cause rotation of the armature 4. Then, the rotational motive force is communicated from the armature 4 to the hub 5 via the plate springs 20, thereby causing rotation of the drive shaft 13.

Of the four magnetic poles formed along the radial direction between the friction surface 15 of the rotor 3 and the friction surface 18 of the armature 4, i.e., the first pole, the second pole, the third pole and the fourth pole counting from the outermost side, the facing area of the first pole is the smallest and the facing areas of the polls become larger toward the inside. As a result, the magnetic flux density is raised on the outer circumference side to achieve an improvement in the level of the force of magnetic attraction on the outer circumference side where the first pole and the second pole have relatively small facing areas.

Such an improvement in the level of the force of magnetic attraction leads to an increased contact surface pressure at the contact surface where the rotor and the armature come into contact with each other, and since this is achieved on the outer circumference side with a large torque radius, an improvement in the transfer torque is realized. In other words, even in a single-armature type electromagnetic clutch, ample force of magnetic attraction is assured. Thus, a transfer torque comparable to that in an electromagnetic clutch adopting a metal-flow type armature is achieved without having to raise the magnetomotive force of the coil.

The friction surface 18 of the disk 4a of the armature 4 and the friction surface 15 of the rotor 3 are set so that their distance becomes wider toward the inner circumference relative to the distance on the outer circumference side. Namely, the inner circumference side of the armature 4 is separated from the vertical reference plane by approximately 30˜50 μm, the inner circumference side of the rotor 3 is separated from the vertical reference plane by approximately 50˜80 μm and overall, there is a 30˜80 μm difference in height between the outer circumference side and the inner circumference side. Since the connection of the armature 4 and the disk 4a is made to start on the outer circumference side by forming a smaller clearance on the outer circumference side in this manner, a sufficiently high level of kinematic friction torque can be obtained even at the initial stage of the connection.

It is to be noted that while the magnetism blocking portion 17 formed at the friction surface 15 of the rotor 3 is constituted with the longitudinal holes 17a and the annular groove 17b, the annular groove 17b may be omitted by increasing the width of the longitudinal holes 17e, or the desired advantage may be achieved by providing the annular groove 17b alone and dispensing with the longitudinal holes 17a as well.

As described above, according to the present invention, in which the facing area of an outer circumference-side magnetic pole is set smaller than the facing area of the corresponding inner circumference-side magnetic pole, the magnetic flux density at the outer circumference-side magnetic pole is increased to improve the contact surface pressure. This, combined with a higher level of magnetic attraction achieved on the outer circumference side where the torque radius is larger, improves the transfer torque without having to increase the magnetomotive force of the coil.

In addition, since the friction surface of the armature disks and the friction surface of the rotor are set so that their distance becomes wider toward the inner circumference side relative to their distance on the outer circumference side and the difference in the height between the outer circumference side and the inner circumference side is set to 30˜80 μm, the contact starts from the outer circumference side where the transfer torque is more significant to ensure that a large transfer torque is achieved from the initial stage of the connection.

Moreover, with a chromate film formed over the disk of the armature, the coefficient of friction is improved to increase of the friction torque and, at the same time, slippage occurs less readily when the disk and the rotor become magnetically held to each other to reduce the noise occurring when the clutch is engaged, as described earlier.

What is claimed is;

1. An electromagnetic clutch having an excitation coil, a rotor with a rotatably supported friction surface and an armature that includes a disk with a friction surface facing opposite said friction surface of said rotor, which causes said disk to be held onto said rotor by an electromagnetic force generated as power is supplied to said excitation coil, wherein:
a magnetism blocking portion for blocking a flow of magnetism is formed to extend along a circumferential direction at an approximate middle position of said disk of said armature along the radial direction; and
a plurality of magnetism blocking portions for blocking a flow of magnetism are formed to extend along the circumferential direction at varying positions set along the radial direction at said friction surface of said rotor, a plurality of magnetic poles are formed at positions along the radial direction between said friction surface of said rotor and said friction surface of said disk of said armature, and a facing area of an outer circumference-side magnetic pole is set smaller than the facing area of an inner circumference-side electromagnetic pole.

2. An electromagnetic clutch according to claim 1, wherein:
said magnetism blocking portion formed at said disk is constituted of a plurality of discontinuous longitudinal holes formed to extend along the circumferential direction.

3. An electromagnetic clutch according to claim 1, wherein:
said magnetism blocking portions at said friction surface of said rotor are longitudinal holes, grooves or a combination thereof formed to extend along the circumferential direction.

4. An electromagnetic clutch according to claim 1, wherein:
when said magnetic poles include a first pole, a second pole, a third pole and a fourth pole, said first hole and said second pole constitute outer circumference-side magnetic poles and said third pole and said fourth pole constitute inner circumference-side magnetic poles, and the facing area of said second pole is set to 1˜1.05, the facing area of said third pole is set to 1.05˜1.10 and the facing area of said fourth pole is set to at least 1.05 relative to the facing area of said first pole set to 1 for reference.

5. An electromagnetic clutch according to claim 1, wherein:
the facing area of said first pole ranges over at least 800 mm.

6. An electromagnetic clutch according to claim 1, wherein:
said friction surface of said disk of said armature and said friction surface of said rotor are set so that the distance between said friction surfaces becomes wider toward the inner circumference side relative to the distance toward the outer circumference side.

7. An electromagnetic clutch according to claim 6, wherein:
said friction surface of said disk of said armature and said friction surface of said rotor are set so that the difference in height between the outer circumference side and the inner circumference side is 30˜80 μm.

8. An electromagnetic clutch according to claim 1, wherein:
a chromate film is formed over said disk of said armature.

9. An electromagnetic clutch according to claim 2, wherein:
a chromate film is formed over said disk of said armature.

10. An electromagnetic clutch according to claim 6, wherein:
a chromate film is formed over said disk of said armature.

11. An electromagnetic clutch according to claim 7, wherein:
a chromate film is formed over said disk of said armature.
